(19) United States
(12) Patent Application Publication
(10) Pub. No.: US 2018/0022028 A1
(43) Pub. Date: Jan. 25, 2018

(54) AN APPARATUS AND A METHOD FOR DETERMINING A QUANTITY OF MATERIAL

(71) Applicants: Pol FORNOS, Sant Cugat del Valles Barcelona (ES); Sergio PUIGARDEU ARAMENDIA, Sant Cugat del Valles Barcelo (ES); David RAMIREZ MUELA, Sant Cugat del Valles Barcelona (ES); Salvador SANCHEZ RIBES, Sant Cugat del Valles Barcelona (ES); HEWLETT-PACKARD DEVELOPMENT COMPANY, L.P., Houston, TX (US)

(72) Inventors: Pol Fornos, Barcelona (ES); Sergio Puigardeu Aramendia, Barcelona (ES); David Ramirez Muela, Barcelona (ES); Salvador Sanchez Ribes, Sabadell (ES)

(73) Assignee: HEWLETT-PACKARD DEVELOPMENT COMPANY, L.P., Houston, TX (US)

(21) Appl. No.: 15/542,394

(22) PCT Filed: Apr. 14, 2015
(86) PCT No.: PCT/EP2015/058069

§ 371 Date: Jul. 7, 2017

(51) Int. Cl. B29C 64/357; B29C 64/386; B29C 64/307; B33Y 40/00; B33Y 50/00

(52) U.S. Cl. CPC B29C 64/357; B33Y 40/00; B33Y 50/00; B29C 64/307; B29C 64/386

(57) ABSTRACT

According to one example, there is provided a method of determining characteristics of a build material. The method comprises obtaining a first quantity of a first build material, determining, for the first build material, the proportion of non-marked build material and marked build material, determining, based on the determined proportion, a first quantity of the first build material to be combined with a second quantity of a second build material to produce a third quantity of mixed build material having a predetermined proportion of marked build material.

### BACKGROUND

Additive manufacturing techniques, such as 3D printing, enable objects to be generated on a layer-by-layer basis. 3D printing techniques may generate a layer of an object by selectively solidifying a portion of a layer of a build material.

### BRIEF DESCRIPTION

Examples will now be described, by way of non-limiting example only, with reference to the accompanying drawings, in which:

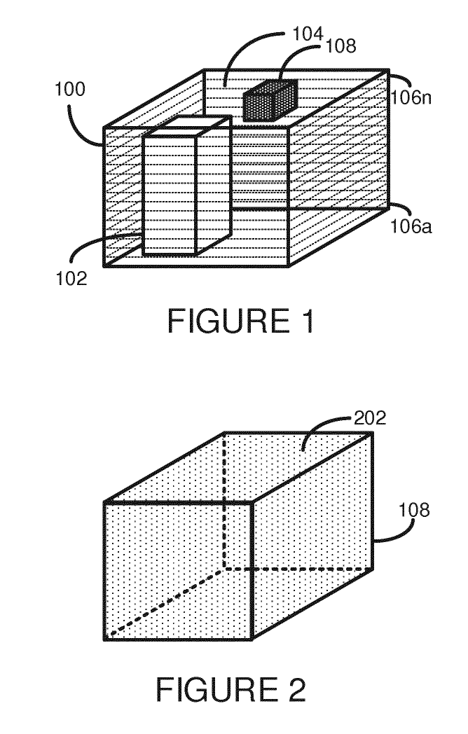

FIG. 1 is an illustration of a build volume according to one example;

FIG. 2 is an illustration of a volume of build material according to one example;

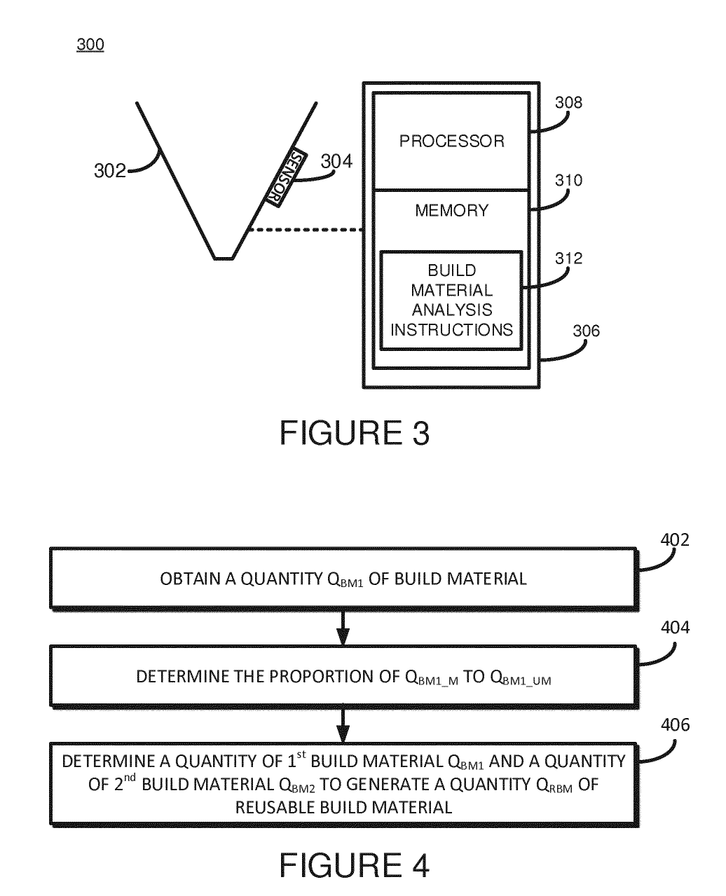

FIG. 3 is a schematic view of a system according to one example;

FIG. 4 is a flow diagram outlining a method of operating a system according to one example;

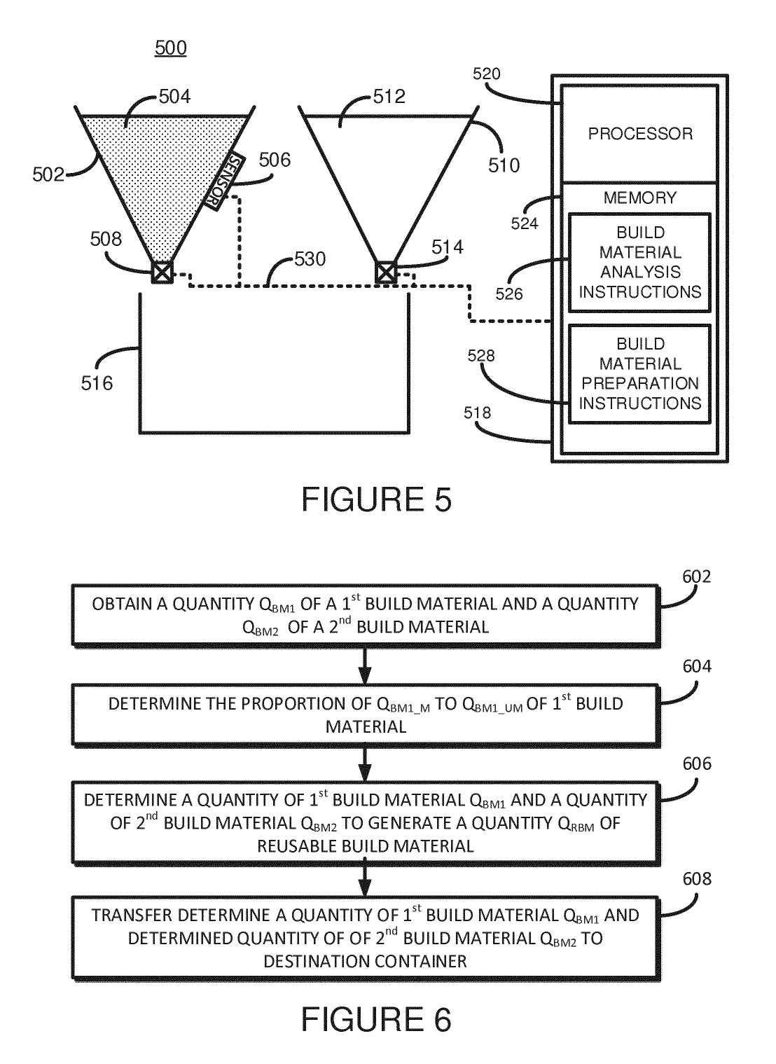

FIG. 5 is a schematic view of a system according to one example;

FIG. 6 is a flow diagram outlining a method of operating a system according to one example;

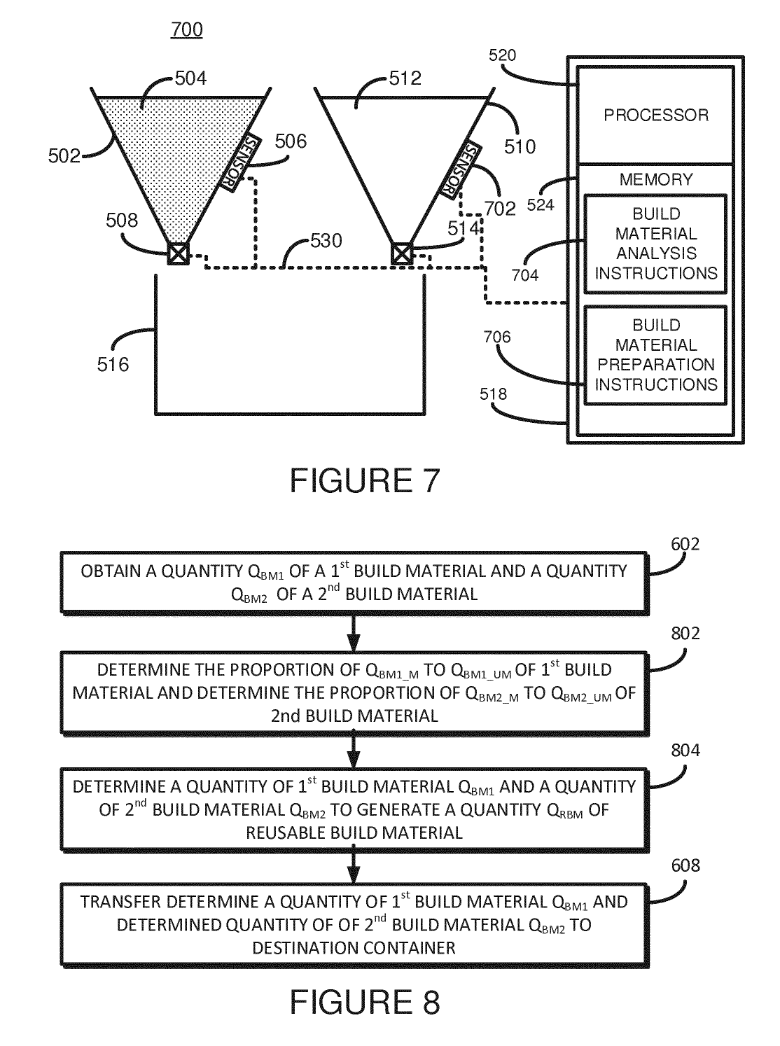

FIG. 7 is a schematic view of a system according to one example;

FIG. 8 is a flow diagram outlining a method of operating a system according to one example;

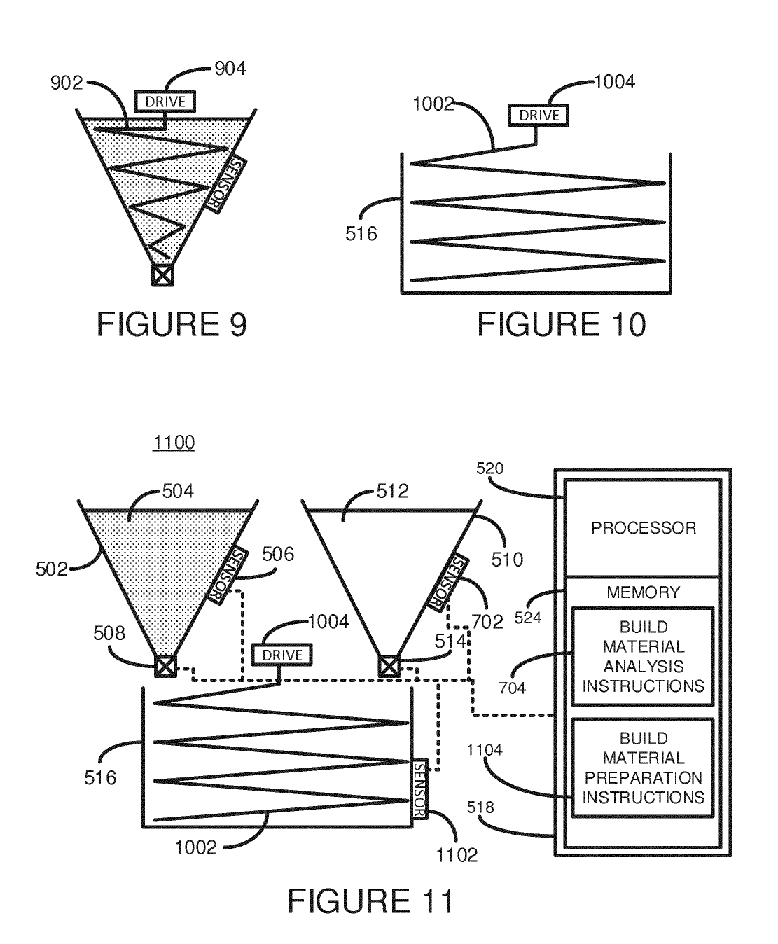

FIG. 9 is an illustration of a portion of a system according to one example;

FIG. 10 is an illustration of a portion of a system according to one example;

FIG. 11 is an illustration of a system according to one example; and

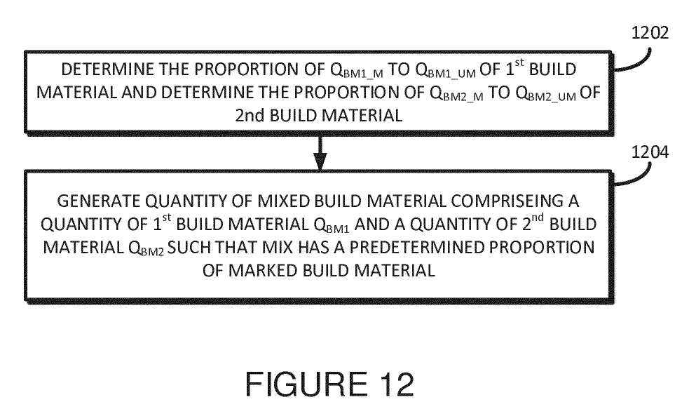

FIG. 12 is a flow diagram outlining a method of operating a system according to one example.

### DETAILED DESCRIPTION

The economic and environmental cost of 3D printing may be lowered through effective reuse of build material that is used during a 3D printing process but that is not solidified.

The term ‘build material’, as used herein, refers to any material suitable for use by a 3D printer to generate 3D objects. The term ‘build material’ is used herein generally to refer to unsolidified build material. The exact nature of the build material may be chosen based on criteria that may include, for example: the solidification mechanism used by the 3D printing technique used; and the properties of a generated 3D object.

In some examples build material may be in the form of a dry powder. In other examples the build material may be in the form of a paste, a gel, a slurry, or the like. Common powder-based build materials may include nylon-12, plaster, and metals.

Some 3D printing techniques selectively solidify portions of a layer of build material by selectively printing a coalescing agent on the layer of build material in a pattern corresponding to a layer of the object being generated, and applying energy to the whole, or a substantial portion, of the layer of build material. Those portions of the build material on which coalescing agent is deposited absorb sufficient energy to cause the temperature of those portions to rise such that coalescence, and subsequent solidification, occurs. Those portions of the build material on which no coalescing agent is deposited do not absorb sufficient energy to cause coalescence, and hence do not solidify.

Such 3D printing techniques may be highly efficient and thus may enable 3D objects to be generated rapidly.

Build material which is not solidified will have been exposed an amount of energy and hence may have undergone physical changes as a result of the energy received, even though the amount of energy received was not sufficient to cause the build material to coalesce and solidify. Unsolidified build material may thus have different properties, such as different physical or mechanical properties, compared to fresh build material that has not previously been used in a 3D printing process.

Using just fresh build material in a 3D printing process may enable high quality objects to be generated, but this comes at high cost. Reusing unsolidified build material, in an appropriate manner, may also enable high quality objects to be generate, but at a lower cost. Furthermore, enabling reuse of unsolidified build material is more environmentally friendly.

Unsolidified build material may be mixed with other build material, such as fresh build material, to form a build material that has acceptable properties for use in subsequent 3D printing processes. For example, forming a mix of previously used build material and fresh build material may enable a build material mix to be formed at a lower cost than using just fresh build material.

Examples described herein provide techniques to enable unsolidified build material that has been previously used in a 3D printing process to be reused in subsequent 3D printing processes, by combining it with a determined quality of a different build material, such as fresh, or ‘fresher’ build material.

Referring now to FIG. 1, there is shown an illustration of the contents of a 3D printing system build module, hereinafter referred to as a build volume 100, after a 3D printing process has been performed by a 3D printing system. For clarity the build module itself is not shown, however the build module may be a suitable container or module in which a 3D printing system may generate a 3D object. For example, the build module may include side walls and a movable floor. A 3D printing system may form successive layers 106a to 106n of build material on and above the movable floor and may selectively solidify portions thereof to generate a 3D object, for example in the manner described above. The thickness of each layer of build material may vary depending on the type of 3D printing system used and configuration parameters, but may in some examples be in the region of about 50 to 200 um.

A 3D printing system may also apply a marking agent to unsolidified build material during a 3D printing process. For example, a 3D printing system may add a marking agent to unsolidified build material, such that the proportion of marked unsolidified build material is a predetermined proportion of unmarked unsolidified build material. A 3D printing system may add marking agent only to portions of unsolidified build material that are recoverable after a 3D printing process has been performed. For example, a 3D printing system may determine not to add marking agent to portions of unsolidified build material that remain within the confines of a generated 3D object. As described in greater detail below, in one example, adding a marking agent to unsolidified build material may be used to enable unsolidified build material that has been previously used during a 3D printing process to be identified and its suitability to be used in subsequent 3D printing processes to be determined. This, in turn, may be used to enable unsolidified build material to be used in further 3D printing processes.

Once a 3D printing process has been completed the build volume 100, V_{BUILD}, comprises a volume 102, V_{S}, of solidified build material, and a volume 104, V_{US}, of unsolidified build material that was not solidified during the 3D printing process. A volume 108, V_{MUS}, of the unsolidified build material has been marked by the 3D printing system with a marking agent.

Although FIG. 1 shows the volume 108, V_{MUS}, of marked unsolidified build material as a single volume, in other examples it may be distributed throughout the volume 104, V_{US}, of unsolidified build material in any suitable manner. For example, the volume 108, V_{MUS}, may be distributed in multiple sub-volumes, or may be dispersed evenly, or unevenly, within the volume 104, V_{US}. The way in which the marked unsolidified build material is distributed may be dependent on the 3D printing system that processed the build volume 100. Accordingly, for the purposes of identifying unsolidified build material, it is the proportion of marked unsolidified build material to unmarked unsolidified build material, and not its distribution, that counts.

A 3D printing system may mark a known and predetermined proportion of unsolidified build material. In one example, a 3D printing system may mark 5%, 10%, 1%, or any other suitable proportion of the recoverable unsolidified build material. The predetermined proportion may be communicated by a 3D printing system in any suitable manner, for example, by way of a user display on the 3D printing system, by way of a non-volatile memory associated with a build module, or in any appropriate manner.

The marking agent may be any suitable agent than may be deposited on a volume of build material that may enable the presence of the applied marking agent to be subsequently detected. In one example, the marking agent may be a coloured agent, such as a coloured ink, or a dye. In another example, the marking agent may be marking agent that is not visible within the visible light spectrum, such as a marking agent that is visible when viewed under ultra-violet light.

The deposition of marking agent on build material should not cause that build material to coalesce and solidify when energy is applied thereto. The marking agent should not unduly affect the properties of the build material on which it is deposited. For example, build material on which marking agent has been applied should remain solidifiable when used in a subsequent 3D printing process as described above. Furthermore, the marking agent should not unduly modify the form of build material on which it is applied. For example, powdered build material on which marking agent has been applied should remain in a powder form.

In another example the marking agent may be the same coalescing agent that is used to cause coalescence and solidification of build material as described above. However, if coalescing agent is used as the marking agent then it has to be deposited with a low-enough coverage density that it does not cause build material on which it has been deposited to absorb sufficient energy to cause coalescence and solidification of build material. Depending on the nature of the coalescing agent and the build material, a suitable coverage density for applying coalescing agent as a marking agent may be a coverage density of between about 0.5% and 4%.

As previously mentioned, the volume V_{US} 104 of unsolidified build material in the build volume 100 may have undergone physical or mechanical changes as a result of the 3D printing processes performed, and may thus have different properties compared to fresh, or fresher, build material. For example, the unsolidified build material may have been exposed to high temperatures.

The build volume 100, V_{BUILD}, may then be transferred to a suitable post-processing module (not shown) to separate the solidified build material from the unsolidified build material. This may be performed in various manners, for example, by sieving the build volume 100, V_{BUILD}, for example in addition to using vibrations, shaking, high-pressure air, or any other suitable process. The unsolidified build material 104 may be collected in a suitable container.

Depending on the nature of the 3D printing process used, and also on the post-processing techniques employed, the volume of unsolidified build material recovered from the build volume 100 may be less than the theoretical quantity of unsolidified build material in the build volume 100. For example, some of the unsolidified build material may have been partially solidified, albeit unintentionally, as a result of thermal bleed from solidified portions of the build material, and may remain attached to solidified portions of the build material.

FIG. 2 is an illustration representing a volume V_{RBM} 202 of unsolidified build material recovered by the post-processing module. The volume V_{RBM} 202 may, as described above, be less than the volume V_{US} 104. The volume 202 includes the volume V_{MUS} 108 of marked unsolidified build material. In one example the volume V_{RBM} 202 of recovered build material is mixed by the post-processing module, or by a separate mixing unit, such that the unmarked build material and the marked build material is substantially homogeneously distributed.

Referring now to FIG. 3, there is shown a schematic diagram of a build material analyser 300 apparatus according to one example. The apparatus comprises a container 302 for receiving build material, a sensor 304 for measuring characteristics of build material within the container 302, and a controller 306 to interpret the measurements provided by the sensor 304. The controller 306 comprises a processor 308, such as a microprocessor, coupled to a memory 310. The memory 310 stores build material analysis instructions 312 that, when executed by the processor 308, cause the processor 308 to determine a proportion of marked build material to unmarked build material within the build material container 302.

In one example, the sensor 304 may be an optical sensor, such as spectrophotometer that is arranged to obtain one or multiple optical characteristics from a portion of build material within the container 302. In one example the optical characteristics may be any one or more of: colour; brightness; chroma saturation; tint; shade; and transparency. In other examples other suitable detectable characteristics may be used. The sensor 304 may be integrated within the container such that the sensor is in contact with build material in the container, or the sensor may be positioned above a transparent window (not shown) incorporated into the container 302. In one example the sensor 304 may comprise a light source to illuminate a portion of build material. In one example the light source may be a visible light source, and in another example the light source may be an ultra-violet light source.

The processor 308 receives signals from the sensor 304 and analyses the signals in accordance with the build material analysis instructions 312. For example, the optical characteristics of unmarked build material may be known and stored within the memory 310. The processor 306 may then compare optical characteristics obtained from build material within the container 302 to determine the proportion of marked build material to unmarked build material in the container 302.

For example, if unmarked build material is a known white colour and the marking agent is a black colour, the colour density of the build material within the container 302 is related to the proportion of marked build material to unmarked build material. For example, if 5% of the unsolidified build material is marked with a marking agent, the processor 306 will determine that the colour density of the build material will also be 5%.

If, for example, the unsolidified build material is re-used in a further 3D printing process (without the addition of any other build material), the recovered unsolidified build material from the further 3D printing process will have 10% of marked build material.

An example method of operating the apparatus 300 will now be described with additional reference to the flow diagram of FIG. 4.

At block 402 a quantity of build material Q_{BM1} is obtained.

At block 404, the controller 306 determines the proportion of the marked build material Q_{BM1}_{_}_{M} to unmarked build material Q_{BM1}_{_}_{UM}.

At block 406, the controller 306 determines a quantity of the build material Q_{BM1} that is to be combined with a quantity Q_{BM2} of second build material to generate a quantity Q_{RBM} of reusable build material. In one example the quantities are chosen such that the quantity Q_{RBM} of reusable build material has a proportion of marked build material that is below a predetermined threshold. In one example, the predetermined threshold may be chosen to be between about 1% and 10%, although in other examples a higher or lower threshold may be chosen.

In one example 100% of the build material Q_{BM1} is chosen to be combined with the determined quantity Q_{BM2} of second build material. In other examples less than 100% of the build material Q_{BM1} may be chosen.

In one example, the second build material Q_{BM2} is fresh build material that has not been previously used in a 3D printing process and which does not comprise any marked build material. In another example, the 2nd build material Q_{BM2} may comprise build material that has been used previously in a 3D printing process, and therefore may comprise a proportion of marked build material. In one example, the second build material may comprise a proportion of marked build material that is lower than the proportion of marked build material of build material QBM. In this sense, the second build material may be considered to be fresher than the first build material.

The determined quantities may then be used to generate a quantity of reusable build material that has acceptable characteristics. For example, the quantities may be input to a build material recycling unit, or may enable a human operator to manually prepare a quantity of reusable build material.

FIG. 5 is a block diagram of a build material recycling system 500 according to one example.

The system 500 comprises a container 502 for receiving build material 504. The received build material 504 may be build material recovered from a previous 3D printing process. A sensor 506 is associated with the container 502, for example as described above to enable characteristics of build material 504 within the container 502 to be determined. The container 502 comprises a build material exit through which build material 504 may be transferred to a removably insertable destination container 516. A regulation device 508, such as an electromechanical valve or shutter is controllable to allow build material 504 to exit the container 502 through the build material exit.

The system 500 also comprises a container 510 for receiving second build material 512. The container 510 comprises a build material exit through which build material 512 may be transferred to the destination container 516. A regulation device 514, such as an electromechanical valve or shutter is controllable to allow build material 512 to exit the container 502 through the build material exit.

Operation of the system 500 is generally controlled by a controller 518. The controller 518 comprises a processor 520, such as a microprocessor, coupled to a memory 524. The memory 524 stores build material analysis instructions 526 that, when executed by the processor 520, cause the processor 520 to determine a proportion of marked build material to unmarked build material within the build material container 502. The memory 524 also stores build material preparation instructions 528 that, when executed by the processer 520, cause the processor 520 to determine a quantity of the build material 504 in the container 502 and a quantity of the build material 512 in the container 510 to transfer into the destination container 516.

A method of operating the system 500 will now be described with additional reference to the flow diagram of FIG. 6.

At 602, a quantity of a 1^{st} build material 504 is obtained in the container 502 and a quantity of a 2^{nd} build material 512 is obtained in the container 510.

At 604, the controller 518 determines, through sensor 506, the proportion of marked build material Q_{BM1}_{_}_{M} to unmarked build material Q_{BM1}_{_}_{UM} in container 516.

At 606, the controller 518 determines a quantity of 1^{st} build material Q_{BM1} and a quantity of 2^{nd} build material Q_{BM2} to be mixed together to generate a quantity of mixed build material Q_{MBM} that has a proportion of marked build material at a predetermined level.

At 608, the controller 518 controls the regulation devices 508 and 514 to transfer the determined quantities of 1^{st} and 2^{nd} build materials to the destination container 516.

In this example the 2^{nd} build material is assumed to be new build material that has not previously been used in a 3D printing process, and hence does not contain a marking agent as described herein. Accordingly, the controller 518 assumes that the 2^{nd} build material does not comprise any marking agent. In a further example, shown in FIG. 7, the 2^{nd} build material may comprise build material that has been previously used in a 3D printing process and therefore may contain marking agent.

The system 700 shown in FIG. 7 additionally comprises a sensor 702 for determining characteristics of the 2^{nd} build material, such as the proportion of marked build material to unmarked build material. The controller 518 comprises build material analysis instructions 704 that, when executed by the processor 520, determine characteristics of both build material 504 in the container 502 and of build material 512 in container 510.

Accordingly, as shown in the flow diagram of FIG. 8, operation of system 700 includes block 802, at which the processor 520 determines the proportion of the marked build material to unmarked build material in the first quantity of build material, and determines the proportion of marked build material to unmarked build material in the second quantity of build material.

At block 804, the processor 520 determines a quantity of the first build material and a quantity of the second build material to be used to generate a quantity of reusable build material that may be used in subsequent 3D printing operations. The controller 520 chooses the first and second quantities such that the quantity of reusable build material comprises a predetermined proportion of marked build material.

In a further example, as illustrated in FIG. 9, one or both of the containers 502 and 510 may additionally comprise a mixing element 902 coupled to a drive mechanism 904. The mixing element 902, such as a mixing blade, a mixing paddle, or the like, can be activated via the drive mechanism 904 to ensure that any marked build material is substantially homogeneously distributed within the build material.

In a further example, as illustrated in FIG. 10, the destination container 516 may additionally comprise a mixing element 1002 coupled to a drive mechanism 1004. The mixing element 1002, such as a mixing blade, a mixing paddle, or the like, can be activated via the drive mechanism 1004 to ensure that the quantities of first and second build material transferred to the destination container 516 are substantially homogeneously mixed together.

In a further example a system 1100, as illustrated in FIG. 11, comprises a further sensor 1102 that is associated with the destination container 516 to enable characteristics of build material within the destination container 516 to be determined. In this way, instead of the controller 520 determining a quantity of first and second build materials to be mixed together, the build material preparation instructions 1104, when executed by the processor 520, cause the controller to transfer a quantity of the first build material 504 to the destination container 516, and to gradually transfer second build material 512 from the container 510, whilst activating the mixing element 1002, until the sensor 1102 indicates that the characteristics of the build material mix in the destination container 516 meet predetermined characteristic.

Example operation of the system 1100 is shown in the flow diagram of FIG. 12. At block 1202, the controller 518 determines the proportion, in the quantity of first build material, of marked build material Q_{BM1}_{_}_{M} to unmarked build material Q_{BM1}_{_}_{UM}, and further determines the proportion, in the quantity of second build material, of marked build material Q_{BM2}_{_}_{M} to unmarked build material Q_{BM2}_{_}_{UM}.

At block 1204, the controller 518 generates a quantity of mixed build material that comprises a quantity of the 1st build material Q_{BM1} and a quantity of the 2^{nd} build material Q_{BM2} such that the quantity of mixed build material has a predetermined proportion of marked build material.

In some examples the build material may be a powder-based build material. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composite materials, powdered ceramic materials, powdered glass materials, powdered resin material, powdered polymer materials, and the like, and combinations thereof. It should be understood, however, that the examples described herein are not limited to powder-based materials or to any of the materials listed above. In other examples the build material may be in the form of a paste, liquid or a gel. According to one example a suitable build material may be a powdered semi-crystalline thermoplastic material.

Although examples described herein refer to build material for use in 3D printing system, in further examples the techniques described herein may be adapted to for use with other suitable kinds of material for use in systems other than 3D printing systems.

According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based coloured ink and pigment based coloured ink, such as inks commercially known as CM993A and CE042A available from Hewlett-Packard Company.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, examples described herein provide a program comprising code for implementing a system or method as claimed in any preceding claim and a machine readable storage storing such a program.

All of the features disclosed in this specification (including any accompanying claims, abstract and drawings), and/or all of the blocks of any method or process so disclosed, may be combined in any combination, except combinations where at least some of such features and/or blocks are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. Apparatus for determining characteristics of a material, comprising:
a first container to receive a quantity of the material;
a first sensor to measure characteristics of the material; and
a controller to:
determine, using the first sensor, the proportion of non-marked material and marked material; and
determine, based on the determined proportion, a first quantity of the material to be combined with a second quantity of a different material to a produce a third quantity of material having a predetermined proportion of marked material.

2. The apparatus of claim 1, further comprising a second container to receive a quantity of a second material, wherein the first and second containers further comprise respective first and second regulation devices to allow material from their respective containers to be transferred into a destination container, and wherein the controller is to control the first and second regulation devices to produce the third quantity of material in the destination container.

3. The apparatus of claim 1, further comprising a second sensor associated with the second container, and wherein the controller is to determine the proportion of non-marked material and marked material in the second material.

4. The apparatus of claim 1, wherein at least one of the first container, the second container, and the third container comprise a mixing element to mix material therein.

5. The apparatus of claim 1, wherein the first sensor is associated with the destination container and wherein the destination container comprises a mixing element, and further wherein the controller is to generate the third quantity of material in the destination container by activating the mixing element and transferring quantities of the first and second materials to the destination container until the controller determines, using the sensor, such that the characteristics of the material in the destination container meet predetermined characteristics.

6. The apparatus of claim 2, wherein the controller is to control the first and second regulation devices to produce a third quantity of material that has a proportion of marked material in the region of between 1% to 10%.

7. The apparatus of claim 1, wherein the sensors are optical sensors and are to detect the presence of an optically detectable marking agent present in a quantity of material.

8. The apparatus of claim 1, wherein the materials are unsolidified build materials for use in a 3D printing system.

9. The apparatus of claim 8, wherein the first material is a build material having been previously used in a 3D printing process performed by a 3D printing system, and wherein the second material is a build material that has not previously been used in a 3D printing process.

10. A method of determining characteristics of a build material, comprising:
obtaining a first quantity of a first build material;
determining, for the first build material, the proportion of non-marked build material and marked build material;
determining, based on the determined proportion, a first quantity of the first build material to be combined with a second quantity of a second build material to produce a third quantity of mixed build material having a predetermined proportion of marked build material; and
generating the third quantity of mixed build material.

11. The method of claim 10, further comprising obtaining a second quantity of a second build material that has not been previously used in a 3D printing process.

12. The method of claim 10, further comprising obtaining a second quantity of a second build material that has been previously used in a 3D printing process and determining the proportion of non-marked build material and marked build material therein.

13. The method of claim 10, wherein determining the proportion of marked build material comprises optically detecting characteristics of the build material.

14. A non-transitory computer readable storage medium encoded with instructions, executable by a processor, comprising:
instructions to:
determine, for a first material, the proportion of non-marked material and marked material;
determine, based on the determined proportion, a first quantity of the first material to be combined with a second quantity of a second material to produce a third quantity of mixed material having a predetermined proportion of marked build material; and
generate the third quantity of mixed build material.
